(19) United States
(12) Patent Application Publication
(10) Pub. No.: US 2026/0204136 A1
(43) Pub. Date: Jul. 16, 2026

(54) Gaming Devices And Methods For Playing Specific Bonus Features Of Games

(71) Applicants: Stuart Pounder, Darlington (GB); Alexandra Candelas, Clearwater Beach, FL (US)

(72) Inventors: Stuart Pounder, Darlington (GB); Alexandra Candelas, Clearwater Beach, FL (US)

(21) Appl. No.: 19/133,454

(22) PCT Filed: Dec. 1, 2023
(86) PCT No.: PCT/US2023/082174

§ 371 Date: May 28, 2025

Related U.S. Application Data
(60) Provisional application No. 63/429,339, filed on Dec. 1, 2022.

(51) Int. Cl. G07F 17/32

(52) U.S. Cl. CPC G07F 17/3267; G07F 17/3213; G07F 17/323; G07F 17/3244

(57) ABSTRACT

Gaming devices such as slot machines and electronic devices (mobiles, tablets, personal computers (PCs)) for playing specific bonus features of games are provided. The invention also encompasses methods for playing such games. In one embodiment, a player can place a wager on whether the reels of the slot machine, after spinning, will display the symbols required for winning the bonus feature. In another embodiment, a player can place a wager and spin the reels of the slot machine, and then the player has a choice between taking a payout based on the symbols displayed on the reel of the slot machine or re-spinning the reels and try to win a larger payout.

### CROSS-REFERENCE TO RELATED APPLICATIONS

The application claims the benefit of PCT International Application No. PCT/US2023/082174 filed Dec. 1, 2023, which claims the benefit of U.S. Provisional Patent Application No. 63/429,339 filed Dec. 1, 2022, the entire disclosures of which are hereby incorporated by reference.

### BACKGROUND OF THE INVENTION

### Field of the Invention

The present invention relates generally to gaming devices such as slot machines and electronic devices (mobiles, tablets, personal computers (PCs)) for playing specific bonus features of games. The invention also encompasses methods for playing such games. In one embodiment, a player can place a wager on whether the reels of the slot machine, after spinning, will display the symbols required for winning the bonus feature. In another embodiment, a player can place a wager and spin the reels of the slot machine, and then the player has a choice between taking a payout based on the symbols displayed on the reel of the slot machine or re-spinning the reels and try to win a larger payout.

### Brief Review of the Related Art

In recent years, more casinos have opened and various gambling devices, such as slot machines, have become more popular. Early slot machines were mechanical and had 3 or 4 or 5 reels that were positioned side-by-side inside of the machine. Each reel had several symbols (e.g., numbers, letters, geometric shapes, characters, objects, images, graphics and the like) printed on it. In practice, a player inserted a coin and pulled a large handle that caused the reels to spin. The player would win the game if the same symbol landed in a row across the reels. The slot machine made ejected coins into a payout tray located at the bottom of the slot machine. The player wins or loses (or the amount that the player wins) depends upon how many matching symbols appear across the reels.

As technology progressed, slot machines having microprocessors and electronic circuits were developed. In these slot machines, electronic controls are used to spin the reels and electronic circuits indicate where the reels will stop spinning and which symbols will match. Today, electronic video slots have become very popular. In some instances, these video slot display rotating reels so that they have the traditional look of mechanical slot machines.

High payouts from slot machines typically occur during bonus rounds of the game being played. To unlock the bonus rounds, a player normally needs to play the game for a relatively long period of time. However, in recent years, new games have appeared in the market, wherein a player can bypass this requirement of playing the game for a long period of time to reach the bonus round. Instead, the player can purchase a bonus round. That is, the player can make a bonus buy. The player does not need to sit at the slot machine and spin the reels for a long period of time. Rather, he/she can reach the bonus feature immediately by buying the bonus feature on the game.

The bonus buy option has some advantages. For example, the player has instant access to the bonus round during the game by making this purchase. The player does not have to keep spinning the reels. The player also has better chances of winning. However, there are some disadvantages with the bonus buy feature. For example, the player could win a prize that is much less than the amount he/she had to spend on the buy feature. For example, the player's wager could be £0.20 and he/she may need to spend £20 (100×£0.20) to activate the bonus feature. That is, the player might need to pay £20 to win a prize that is based on a £0.20 wager.

It would be desirable to have gaming devices and methods, wherein the player is not required to purchase the feature option and does not run the risk of losing a significant amount of money. The present invention provides such gaming devices and methods. Other advantages, features, and benefits of the gaming devices and methods of the present invention are described further below.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a flowchart showing one embodiment of the method of the present invention; and

FIG. 2 is a flowchart showing another embodiment of the method of the present invention.

### DETAILED DESCRIPTION OF THE INVENTION

The present invention relates generally to gaming devices such as slot machines for playing specific bonus features of games. The invention also encompasses methods for playing such games. In one embodiment, a player can place a wager on whether the reels of the slot machine, after spinning, will display the symbols required for winning the bonus feature. In another embodiment, a player can place a wager and spin the reels of the slot machine, and then the player has a choice between taking a payout based on the symbols displayed on the reel of the slot machine or re-spinning the reels and try to win a larger payout.

### Feature Spin

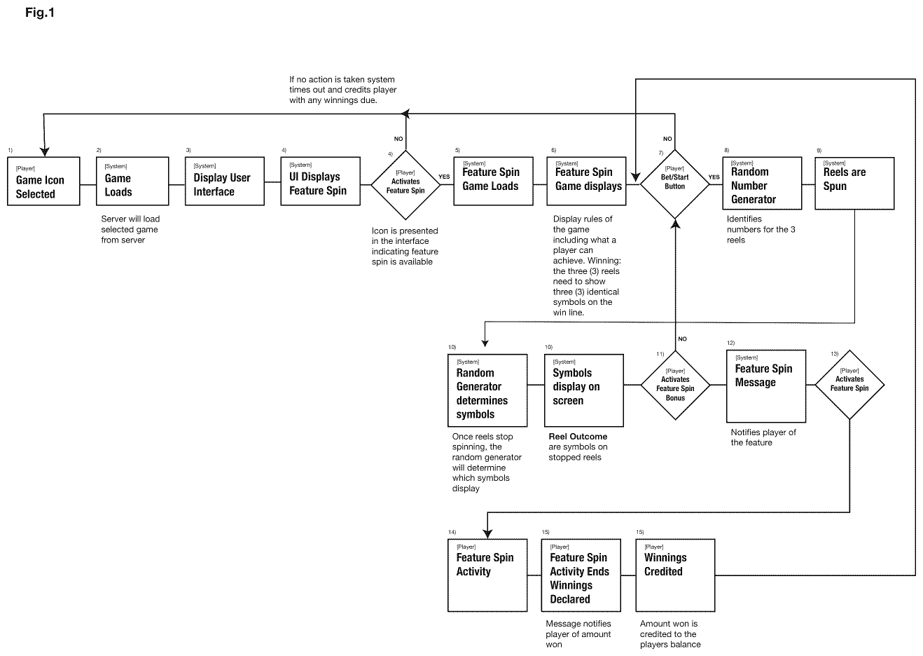

Referring to FIG. 1, a flowchart of one embodiment of the operation of the gaming system and method for “Feature Spin” is shown.

This operation of the game to Feature Spin can be further summarized by the following steps: 1) a game is loaded by pressing a game icon on the gaming device; 2) a server loads the selected game; 3) a player is presented with a game user interface; 4) The player interface provides the player with the option to activate the Feature Spin game of the present invention; 5) Upon activating the Feature Spin game, the Feature Spin game loads; 6) The Feature Spin game is displayed on the screen with information describing the rules of the game including what a player will achieve and how it will be achieved (e.g., the three (3) reels will need to show three (3) identical symbols on the win line); 7) the player presses the bet/start button; 8) the random number generator identifies the numbers for the three reels; 9) the reels are spun; 10) the random number generator of the gaming device generates which symbols will be displayed on the reels after the reels stop; The symbols on the stopped reels (the “reel outcome”) is displayed on the screen for the player; 11) If the result does not activate the Feature Spin bonus, then the player returns to Step 7 above. On the other hand, if the result activates the Feature Spin bonus, then the player moves to Step 12 below; 12) The Feature Spin message appears and notifies the player of what the feature is; 13) the player activates the Feature Spin; 14) the Feature Spin activity occurs; 15) The Feature Spin activity ends with a message notifying the player and the amount won; 16) The amount won by the player is credited to the player's balance; and 17) the player returns to Step 7 above.

### Feature ReSpin

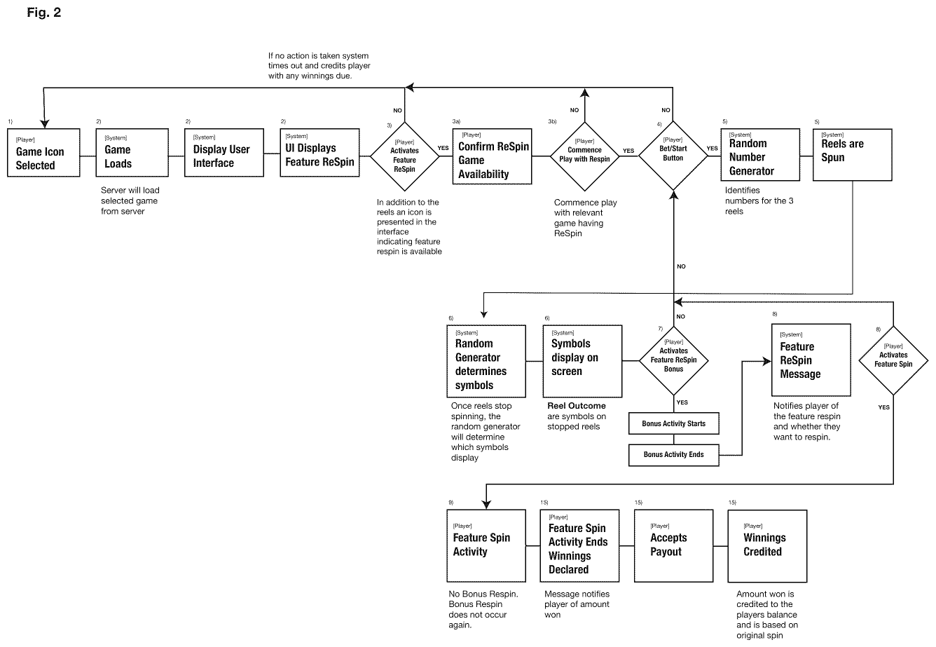

Referring to FIG. 2, a flowchart of another embodiment of the operation of the gaming system and method for “Feature Respin” is shown.

The operation of the game can be further summarized by the following steps: 1) Player loads a game by pressing a game icon; 2) the game loads; 3) Player activates Feature Respin game by either: a) confirming that the Feature Respin game be made available, or b) commencing play of a relevant game having Feature Respin; 4) Player makes a bet by pressing the start/bet button; 5) The reels are spun and the random number generator of the gaming device generates which symbols will be displayed on the reels after the reels stop; 6) The symbols on the stopped reels (the “reel outcome”) is displayed on the screen for the player; 7) If the Feature Respin bonus is not awarded on the reel outcome, then the player returns to Step 4 above. However, if the Feature Respin bonus is awarded, the player moves onto Step 8 below; 8) The Feature Respin message describes the type of feature and notifies the player that Feature Respin is active; 9) The Feature Respin activity occurs. 10) The Feature Respin activity ends and the player is presented with a choice: the player can decide to take the payout based on the original spin or the player can decide to active the Feature Respin game and take a second chance at winning a larger payout. For example, the player plays the game and the three (3) reels show two (2) identical symbols. The player can take a payout based on the reels showing these two (2) identical symbols. Or, the player can take a chance and try to get a payout for the three (3) reels having three (3) identical symbols. In this case, when the Respin button is pressed, the first two reels with the matching symbols are frozen, and the third reel spins again. 11) As described above, if the player decides to take the first spin of the reels and the corresponding payout, then the game is finished and the player returns to Step 4 above to start a new game. On the other hand, if the player decides to activate the Feature Respin game, then the player moves to Step 12 below; 12) In this step, the player presses the Respin button and the Feature Respin game is activated—this includes player messaging describing the game; 13) the Feature Respin activity occurs (e.g., two reels are frozen, and the third reel spins again); 14) the Feature Respin activity ends and the player is awarded the payout; and 15) the player returns to Step 4 above.

### Benefits of Feature Spin Game

The Feature Spin game of the present invention provides many advantages and benefits as discussed below. In general, slot games entail vast amounts of reel symbols, reel strips, win lines, reel layouts and features, themed accordingly to the individual game. Creating an array of 0,000's of similar slot games, with varied levels of complexity. A significant element of the slot game make up is the features—the key way in which game providers distinguish games. Resulting in Operators needing to communicate the way in which games function on a consistent basis, in addition resulting in high levels of customer confusion. Slot game design splits return to player across core elements—base game win lines, base game features, primary features, players that play only for the feature are forced to play elements of games that they have no desire to and do so in order to achieve feature entertainment/satisfaction. This results in time precious players not been able to have slot game satisfaction when they desire feature play only. This also corelates to an operator problem that they cannot satisfy player demands or needs, return to player is distributed across multiple areas when their customers could chose to play only for the feature. Current game design means that players are required to play games for longer to achieve their desired entertainment and outcome. Features are triggered in multiple different ways on current slot games. Volatility consistency is unachieved in slot game design due to the enlarged reel strips.

In one embodiment of the present invention, the game includes three (3) reels with two (2) symbols and one (1) win line; the 3 reels contain reel strips less than 6 symbols long. The 2 symbols within the invention are an active symbol and an inactive symbol. The visual difference between the two symbols is that one symbol has a light finish and the other symbol has a dull finish. The game of the present invention triggers the exact feature that is available during the standard play of game. The game allows players to play only for the reason they want to play. The game ensures that Return to Player can be distributed to players where they desire, and operators will specifically be able to satisfy player demand. The game of the present invention saves players' time. They directly will get feature play satisfaction without spending time on areas that they do not choose to play. The timebound link between gambling habit and problem gambling habit will be alleviated for those areas where players are now able to play specifically for the reason they choose. The game of this invention consistently satisfies demand of consistent requirements/understanding of players. Invention has a consistent reel strip enabling a consistent experience.

Feature Spin is a new way of playing slot games, applicable to both online and offline real money gaming. Feature Spin could be classified as a mode of play or a side bet. There is a demand from players to bet for the feature only and take away the typical of a slot game.

As discussed above, with the Feature Spin game, there is potential to win on every spin. Feature Respin, as discussed further below, is active after the Feature Spin has played out (where a player is given the choice to take wins or play Feature Spin again.) If a player does not activate Feature Spin, then he/she can play the standard version of the game. If the player does not press bet/start, then the game sits idle until an action occurs. The game sits until either the player exits or the browser/terminal is shut down. Preferably, the games always have exactly three (3) reels. In other less preferred embodiment, the games have less than three (3) reels or greater than three (3) reels.

Feature Respin is a second chance or try again mechanic applicable to both online and offline real money gaming. The present invention to a Feature Respin game allows players, once they have had the feature experience, to decide whether they want to retain the feature experience or to have the feature again. This would be presented at the end of the feature, wherein a pop-up message would appear asking the question. The second chance of the feature could return more money or less money than the first chance however the player, in any event, will keep the second chance amount. The two feature chances would be calculated at the beginning of the initial spin (triggering spin). The first feature will be awarded and the second feature will already be pre-determined but not known to the player.

There are various embodiments for playing the Feature Respin game including the following: 1) Feature Respin is available on all games after a feature; 2) Players are given the option to pay for Feature Respin at the end of a feature; and 3) Players are given the option to enable Feature Respin prior to an individual spin occurring-either free of charge, for a direct cost or within a different mode of play.

As discussed above, with the Feature Respin game, if the player does not take the payout on the first feature, then he/she can automatically collect the payout from the second feature. However, this action is not required. Rather, the player can continue playing and have an indefinite number of respins. The player needs to trigger a feature/bonus. Preferably, there are three (3) reels and each reel has five (5) columns. But, there are some games with four (4) reels and five (5) columns; and some games with three (3) reels and three (3) columns. In general, Feature Spins is a mechanism for triggering the feature.

It should be understood that the devices, machines, systems, methods, processes, and the like described and illustrated herein represent only some embodiments of the invention. It is appreciated by those skilled in the art that various changes and additions can be made to the devices, machines, systems, methods, processes, and the like without departing from the spirit and scope of this invention. It is intended that all such embodiments be covered by the appended claims.

I claim:

1. A gaming device, comprising:
a display device;
a game displayed by the display device, wherein there are at least three reels in the game and each reel includes multiple symbols printed thereon;
a player input device;
a processor, wherein the processor operates with the display device, game displayed by the display device, and player input device to: a) receive a wager from a player to activate a feature spin of the game which causes the at least three reels to spin, wherein randomly generated symbols are displayed on a win line of the reels after spinning; b) provide any feature spin award which is determined based on the displayed symbols on the win line; c) if a feature spin is awarded, provide a feature spin play of the game so that the player can activate this play of the game; and d) display any awards given after the player makes the feature spin play of the game.

2. The gaming device of claim 1, wherein three matching symbols on the win line are required to provide a feature spin award.

3. The gaming device of claim 1, wherein if a feature spin is awarded, this award is displayed on the display device and includes instructions on how to activate the feature spin play of the game.

4. The gaming device of claim 1, wherein the award for winning the feature spin play of the game is money which is credited to a player account.

5. The gaming device of claim 1, wherein the player can activate a second game so that the processor operates with the display device, game displayed by the display device, and player input device to repeat Steps a) through d).

6. The gaming device of claim 1, wherein the player has an option of playing a standard game or activating a game so that the processor operates with the display device, game displayed by the display device, and player input device to perform Steps a) through d).

7. A gaming device, comprising:
a display device;
a game displayed by the display device, wherein there are at least three reels in the game and each reel includes multiple symbols printed thereon;
a player input device;
a processor, wherein the processor operates with the display device, game displayed by the display device, and player input device to: a) receive a wager from a player to activate a feature respin of the game which causes the at least three reels to spin, wherein randomly generated symbols are displayed on a win line of the reels after spinning, b) provide any feature respin award which is determined based on the displayed symbols on the win line, and c) if a feature respin is awarded, provide a feature respin play of the game so that the player can activate this play of the game; d) display any awards given after the player makes the feature respin play of the game; e) provide the player with a choice of:
i) either taking the award given in Step d) from the previously played feature respin play, or
ii) declining the award given in Step d) from the previously played feature respin play; and
f) if the player declines the award given in Step e), then provide the player with a second feature respin play of the game so that the player can activate this play; and g) display any awards given after the player makes the second feature respin play of the game.

8. The gaming device of claim 7, wherein the award for winning the second feature respin play of the game in Step g) is money which is credited to a player account.

9. The gaming device of claim 7, wherein the player takes the awards given in Step d) and the award is money which is credited to a player account.

10. The gaming device of claim 1, wherein the player can activate a second game so that the processor operates with the display device, game displayed by the display device, and player input device to repeat Steps a) through g).

11. A method for operating a gaming device, comprising the steps of:
i) providing a gaming device, the gaming device comprising: a display device;
a game displayed by the display device, wherein there are at least three reels in the game and each reel includes multiple symbols printed thereon; a player input device; and a processor, wherein the processor operates with the display device, game displayed by the display device, and player input device;
ii) placing a wager to activate a feature spin of the game which causes the at least three reels to spin, wherein randomly generated symbols are displayed on a win line of the reels after spinning, s
iii) providing any feature spin award which is determined based on the displayed symbols on the win line,
iv) providing, if a feature spin is awarded, a feature spin play of the game so that the player can activate this play of the game; and
v) displaying any awards given after the player makes the feature spin play of the game.

12. A method for operating a gaming device, comprising:
i) providing a gaming device, the gaming device comprising a display device;
a game displayed by the display device, wherein there are at least three reels in the game and each reel includes multiple symbols printed thereon; a player input device; and a processor, wherein the processor operates with the display device, game displayed by the display device, and player input device
ii) placing a wager from a player to activate a feature respin of the game which causes the at least three reels to spin, wherein randomly generated symbols are displayed on a win line of the reels after spinning,
iii) providing any feature respin award which is determined based on the displayed symbols on the win line,
iv) providing, if a feature respin is awarded, a feature respin play of the game so that the player can activate this play of the game;
v) displaying any awards given after the player makes the feature respin play of the game;
vi) providing the player with a choice of:
a) either taking the award given in Step d) from the previously played feature respin play, or
b) declining the award given in Step d) from the previously played feature respin play; and
vii) providing the player with a second feature respin play of the game if the player declines the award given in Step e) so that the player can activate this play; and
viii) displaying any awards given after the player makes the second feature respin play of the game.
